(19) United States
(12) Patent Application Publication
(10) Pub. No.: US 2005/0173892 A1
(43) Pub. Date: Aug. 11, 2005

(54) No-ramp trailer

(76) Inventor: Leo Frank Terminello, Miami, FL (US)

Correspondence Address: LEO TERMINELLO, 1551 NE MIAMI GARDENS DRIVE # 318, MIAMI, FL, 33179, US

(21) Appl. No.: 10/772,931

(22) Filed: Feb. 5, 2004

(51) Int. Cl. B60D 1/00

(52) U.S. Cl. 280/490.1

(57) ABSTRACT

A method of manufacture of vehicular trailers comprised of: a suspension system (A) slidably attached to a load bearing frame structure (B) enabling said load bearing frame structure (B) to horizontally pass over the vertical axis of said suspension system (A); a means (C) to apply force so as to cause or tend to cause motion toward the source of the force; a rotatable means (D) allowing said load bearing frame structure (B) to roll along a surface; a floating link variable height hitch assembly (E) providing a means for the tongue of the trailer to move vertically and past the horizontal axis of a generic hitch receiver (10d). The combined dynamics of (A),(B),(C), and (D) enabling said load bearing frame structure (B) to deploy or retrieve a load at or beneath a ground plane of the towing vehicle; an asymmetrical design of said floating link adjustable hitch assembly providing a means to enable adaptation to any height towing vehicle (120) by rotation in the generic hitch receiver (10d) 180°; in the case of the preferred embodiment hereof a boat trailer combination (200) providing a means to launch and retrieve a boat into or out of the water at or below the ground plane of the towing vehicle without a launching ramp or extraneous apparatus and without water contamination; in the case of an additional embodiment hereof a multiple use vehicular trailer providing a means to deploy to or retrieve to or from a ground plane equal to or beneath that of the towing vehicle.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION PREFERRED EMBODIMENT

1. Field of the Invention

This invention relates to a method of manufacture of vehicular trailer, the preferred embodiment being a boat trailer combination.

### BACKGROUND OF THE INVENTION PREFERRED EMBODIMENT

2. Prior Art

The present day method of vehicular trailering of boats to a location for launching and/or retrieving boats is fraught with safety hazards and obstacles to the convenient use thereof. The state of the art in boat trailering has not addressed the issue of the elimination of boat launching ramps and other related apparatus. The launching ramp is particularly the root problem in boat trailering safety and obstacles to convenient use.

1. Safety.

Immersion in water and more so in salt-water causes the loss of lubricant and corrosion damage to wheel bearings, brakes, and electrical systems.

A wheel bearing that has lost the necessary lubrication during operation produces extreme heat that will fuse the bearing to the axle causing the wheel to lock. The devices that attempt to seal in the lubricant and seal out the water are not totally effective and the sealing effect diminishes with wear. This is certainly a maintenance cost factor as well as a safety hazard.

Corroded brakes will fail. Devices that attempt to flush the brakes after submersion are not effective and rarely used in every day situations. I have never seen a person flush his brakes after deploying the boat. Typically it may be hours before this is done if then and is not effective. This is certainly a maintenance cost factor as well as a safety hazard.

Electrical wiring systems, even so called water proof designs, are damaged beyond repair from immersion in water and more so salt-water. Corroded electrical systems cause lights not to function and convert the trailer into an invisible obstacle at night. This is certainly a maintenance cost factor as well as a safety hazard.

The vast array of design configurations dictates a need for a ready means to safely distribute the weight of the boat on the trailer in relation to the position of the suspension system. The amount of weight at the tongue or hitch is critical to the safe handling faculties of the towing vehicle. All objects carried on a trailer have various weight distribution characteristics. The placement of the many different boats customarily carried on a trailer combined with the differences in the location and weight of the engines or power plants cause a severe safety hazard not addressed in the prior art.

On irregular terrain the tongue weight varies considerably, the towing vehicle is often not on the same ground plane as the vehicle trailer combination. The effect of the tongue of the trailer being confined to a static position combined with the irregular terrain would cause the force on the tongue to vary erratically. The handling characteristics of the towing vehicle would be adversely and unpredictably affected as it proceeds along the irregular terrain.

Unfortunately for society, many drink and drive. An impaired operator of a multi-ton trailer with no brakes, no lights, and uneven weight distribution is unthinkably dangerous.

2. Obstacles to Convenient Use:

Locating and paying a fee to use a launch ramp is tedious and expensive. There is a myriad of locations in the world with no launching facilities, both near and far.

The Florida Keys is a case in point. The Florida Keys, a paradise for aquatic recreation, is an enormous chain of hundreds of islands stretching for over one hundred and twenty miles into the Gulf Stream. Uncountable areas are inaccessible to the public for lack of launching facilities. The facilities that are available are scarce and expensive. Available facilities are very expensive to build. Understandably, local and federal zoning rules prohibit the construction of launching facilities in much of the Keys area.

U.S. Pat. No. 4,681,334 to O'Brian, Jr. Jul. 21, 1987 FIG. 8 is one case of the prior art in point. The “Summary of The Invention” therein states: “This trailer combination, therefore is a new and improved apparatus to prevent exposure to water, of boat trailer bearings.” On the contrary the wheels in O'Brian, Jr.'s invention must be submersed as seen in FIG. 8 hereof showing FIG. 7A and 7B of O'Brian, Jr.'s patent:
(a) The aforementioned drawings clearly show the wheels in the water.
(b) The conditions at a typical launching facility include wakes from other craft and choppy water created by the wind. These two factors alone would cause the bearings to get wet.
(c) When the trailer is taken out of the water the rotation of the wheels would then saturate the bearings.
(d) O'Brian's design has no consideration for preventing water damage to the brakes.
(e) O'Brian's design has no consideration for preventing water damage to the electrical system.
(f) O'Brian's design requires a launching ramp.
(g) O'Brian's design has no provision for readily adjustable weight distribution.

U.S. Pat. No. 4,623,161 to Sprague Nov. 18, 1986 FIG. 9 is an example of the absolute neglect of the safety hazards and obstacles to convenient use of this art prior to O'Brian's attempt above. Most notable of Sprague's patent is the immersion into the water of the suspension and about two thirds of the trailer clearly shown in FIG. 9.

Patent No. Des. 368053to Gallagher Mar. 19, 1996 FIG. 10 is typical of what is seen in the majority of boat trailer designs. All the neglected safety issues in the design and usage of boat trailer are embodied in the Gallagher boat trailer. This is the state of the art a device with built in safety hazards and restrictive usability.

### BACKGROUND OF INVENTION PREFERRED EMBODIMENT—OBJECTS AND ADVANTAGES

Accordingly objects and advantages of my boat trailer combination are:

My boat trailer combination solves the fundamental problems associated with using a launching ramp or other apparatus: no ramp nor other apparatus is required. Never being immersed in water makes the maintenance of my boat trailer combination comparatively low. My boat trailer combination will reduce accidents resulting from bearing, brake and electrical malfunctions. The design of my boat trailer combination equates to low construction costs. Basic components are used for the most part. Any trailer manufacturer could build my boat trailer combination with little or no re-tooling.

My boat trailer combination has a readily adjustable suspension positioning system. A prior determination of the maximum weight capacity of the tongue or hitch should be made. One method of many is: before hooking to the trailer combination, load the rear of the towing vehicle with the maximum amount of weight allowable for that particular vehicle; make a linear measurement from the ground plane to the hitch. Thereafter this figure may be used to make a proper determination as to the weight on the tongue or hitch.

The asymmetrical design of my floating link adjustable hitch assembly enables simple adaptation to any height towing vehicle. My floating link adjustable hitch assembly provides a means for the tongue of the trailer to vertically pass the horizontal axis of a generic hitch receiver. The said floating link adjustable hitch assembly may be reversed by removing it from a generic receiver, rotated and replaced in the generic hitch receiver; this has two advantages: 1. provides an extreme alternate option for the vertical movement of the tongue of the boat trailer combination and 2 an unparalleled range of height positioning options.

My boat trailer combination is very well suited to wilderness locations. The accessibility of which is dependant on the towing vehicle. On irregular terrain, the towing vehicle is often not on the same ground plane as the boat trailer combination. The effect of the tongue of the trailer being confined to a static position combined with the irregular terrain would cause the force on the tongue to vary erratically. The handling characteristics of the towing vehicle would be adversely and unpredictably affected as it proceeds along the irregular terrain. The floating link adjustable height hitch assembly of my boat trailer combination allows the tongue of my boat trailer combination to move vertically as required by the differences in the terrain beneath the towing vehicle and that of boat trailer combination. The tongue of the trailer can pass the horizontal axis of the generic hitch receiver. This range of movement would relieve much if not all of the erratic changes in force on the towing vehicle. My boat trailer combination provides an unparalleled range of hitch height adjustability suited to any towing vehicle.

My boat trailer combination will free enthusiasts to launce their craft in the most remote of regions. Instead of dealing with crowds at a public launching facility, a remote area with possibly no one else would be the base of operation for a fishing trip for example. Many enthusiasts want to launch and retrieve their boats in many areas in a single time frame. Of course money would be saved because there would not be fees for the use of commercial ramps. A wide range of water-front locations are suitable for my boat trailer combination. For example any water-way that is several inches to several feet below the ground level may be suitable. The wheels my of my boat trailer combination remain in a place that is safe and stable while deploying or retrieving the boat into or out of the water.

My boat trailer will roll on the water bottom until the boat is in deep enough water to float off. Alternately my boat trailer frame will rest on the bank edge of a water-way and the boat would float off. In some cases the trailer frame would rest on the bank of the water-way and slide until the boat floated off. Another situation is the trailer would rest and slide on the bank edge of the water-way and the rollers would contact the water-body floor and roll until adequate depth was reached.

My boat trailer combination makes formerly inaccessible and desirable locations readily accessible. The overcrowding at launching facilities would decrease. My boat trailer combination would greatly enhance the boating industry's economic position. Other objects and advantages will become apparent from the specification and drawings.

### SUMMARY

In accordance with the present invention a boat trailer combination comprising a plurality of configured generic components operating together with a towing vehicle to launch and retrieve a boat into or out of the water at or below the ground plane of the towing vehicle without a launching ramp or extraneous apparatus and without water contamination.

### DRAWINGS—FIGURES PREFERRED EMBODIMENT

FIG. 1 a perspective view from the left hand longitudinal side of a boat trailer combination

FIG. 1a a perspective view from the left hand longitudinal side of a boat trailer combination

FIG. 2 a perspective view of the right hand side of a suspension system components

FIG. 2a a plane view of FIG. 2

FIG. 3 a detailed plane rear view of the boat trailer combination showing in part the complete suspension system

FIG. 3a a full fender

FIG. 4 a rear plane view of a slide/guide

FIG. 4a an I-beam alternative embodiment of a slide guide

FIG. 5 a detailed perspective view of a floating link, adjustable height, hitch assembly

FIG. 6 a detailed perspective view of a roller wheels assembly

FIG. 6a a detailed perspective view of a section of a roller wheels assembly

FIG. 7 a plane view of a towing vehicle and the boat and trailer combination at a waterfront setting

FIG. 7a scenario one

FIG. 7b scenario two

FIG. 7c scenario three

FIG. 7d scenario four

FIG. 7e a floating link adjustable hitch assembly reversed

FIG. 7f a boat trailer combination with the suspension system in a typical predetermined position

FIG. 8 O'Brian Patent No. 4,681,334

FIG. 9 Sprague Patent No. 4,623,161

FIG. 9a Gallagher Patent No. Des. 368053

FIG. 10d a generic hitch receiver

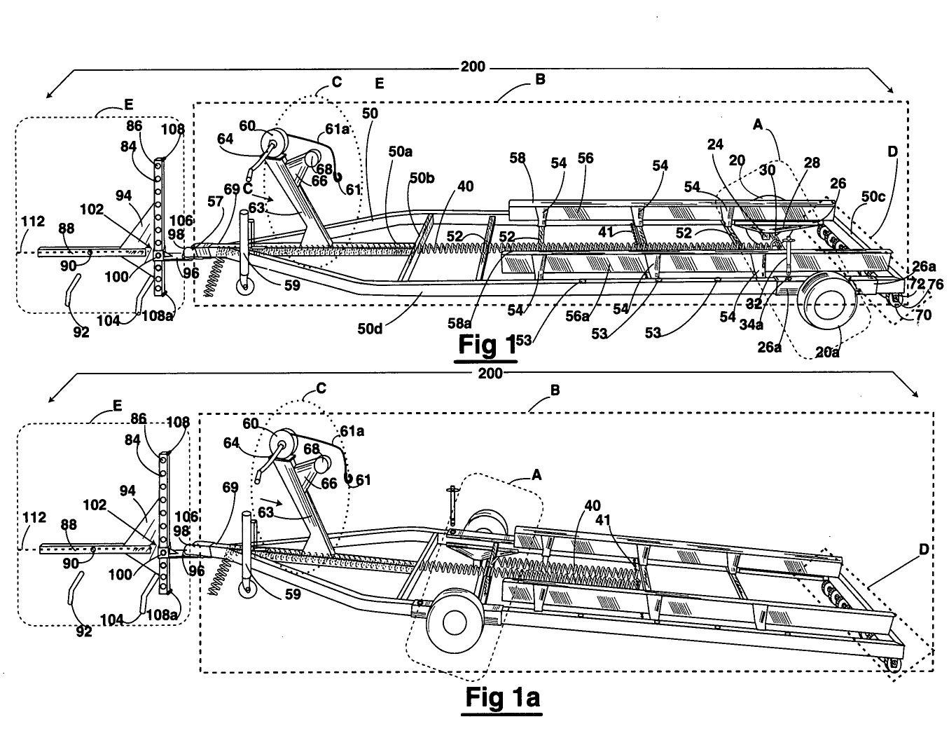

### DETAILED DESCRIPTION—FIGS. 1a and 1b PREFERRED EMBODIMENT

The overall structure of the preferred embodiment of the present invention is illustrated in FIG. 1 and FIG. 1a.

FIG. 1 and FIG. 1a show:
A slidable positioning suspension assembly A composed of the following elements: A wheel 20 is attached to a torsion bar 24 on the right hand side of the boat trailer combination 200. A wheel 20a is attached to a torsion bar 24a on the left hand side of the boat trailer combination 200. A torsion bar 24 is attached to a gusset 28 on the right hand side of the boat trailer combination 200. A torsion bar 24a is attached to a gusset 28a on the left hand side of the boat trailer combination 200. A slide/guide 26 is attached to the gusset 28 on the right hand side of the boat trailer combination 200. A slide/guide 26a is attached to a gusset 28a on the left hand side of the boat trailer combination 200. A transverse axle 30 is attached to the gusset 28 on the right hand side of the boat trailer combination 200 and to the gusset 28a on the left hand side of the boat trailer combination 200.

A load bearing frame components assembly B composed of the following elements: A longitudinal load bearing frame component 50 on the right hand side of the boat trailer combination 200 is attached at the rear at a right angle to the right hand side of a transverse rear load bearing frame component 50c. The left hand side of the transverse rear load bearing frame component 50c is attached at a right angle to the rear of longitudinal load bearing frame component 50d on the left hand side of the boat trailer combination 200. The front of the longitudinal load bearing frame component 50d is joined with the front of the forward longitudinal load bearing frame component 50a, and the front of the longitudinal load bearing frame component 50 on the right hand side of the boat trailer combination 200. The forward longitudinal load bearing frame component 50a is attached at the rear to a transverse forward load bearing frame component 50b. Several transverse cross members 52 are attached to the longitudinal load bearing frame component 50 on the right hand side of the boat trailer combination 200 and to the longitudinal load bearing frame component 50d on the left hand side of the boat trailer combination 200. A transverse forward load bearing frame component 50b is attached to the longitudinal load bearing frame component 50 on the right hand side and to the longitudinal load bearing frame component 50d on the left hand side of the boat trailer combination 200. Several bunk supports 54 are attached to the several transverse cross members 52 on the right hand side and the left hand side thereof. A right hand side longitudinal bunk 56 is attached to the several bunk supports 54 on the right hand side of the boat trailer combination 200. A left hand side longitudinal bunk 56a is attached to the several bunk supports 54 on the left hand side of the boat trailer combination 200. A bunk cushion 58 is attached to the right hand side longitudinal bunk 56. A bunk cushion 58a is attached to the left hand side longitudinal bunk 56a. A ball coupler 57 is attached to the front of the forward longitudinal load bearing frame component 50a. A trailer jack 59 is attached to the forward longitudinal load bearing frame component 50b.

A winch assembly C composed of the following elements:
A winch stand 63 is attached at its base to the longitudinal forward load bearing frame component 50a and the top of the winch stand 63 is attached to a winch mount 64. A winch 60 is attached to a cable 61a The cable 61a is attached to a winch cable hook 61. A bow stop bracket 66 is attached to the winch stand 62. A bow stop 68 is attached to the bow stop bracket 66. An electrical cable 40 is located inside of the forward longitudinal load bearing frame component 50a and exits through the middle of the transverse forward load bearing frame component 50b and then inside of the axle 30. The electrical cable 40 is divided and routed in the axle 30 to the brake, stop, and tail lights 23 and 23a on the fenders 22 and 22a. A transverse coil spring 41 is located midway between the transverse forward load bearing frame component 50b and the axle 30 and attached to the load bearing frame component 50 on the right hand side of the boat trailer combination 200 and to the longitudinal load bearing frame component 50d on the left hand side of the boat trailer combination 200.

A roller wheels assembly D composed of the following elements:
Several roller wheels 70 attached to an axle 76. The axle 76 is supported by several axle supports 72 and several eye bolts 73. Several washers 74. Several PVC spacers 78. Several cotter pins 82 and several opposed openings 83.

A floating link adjustable height hitch assembly E composed of the following elements: A horizontal hitch component 88 is linearly attached to and aligned with the horizontal axis of the vertex of the two shorter sides of the scalene triangular gusset 94. The longest side of the scalene triangle gusset 94 is attached to the longitudinal center of a vertical hitch component 84. A slide/guide 100 surrounds the vertical hitch component 84 except for a vertical slot 102 wider than the thickness of the scalene triangular gusset 94 allowing clearance for said slide guide to move vertically the full length of the vertical hitch component 84 past the horizontal axis of a generic hitch receiver 114. The vertical hitch component 84 has several horizontally opposed openings 86 for the insertion or removal of a bolt 104 to secure or release the slide/guide 100 with a horizontally opposed opening 106 for the bolt 104. A ball mount 96 is attached to the slide/guide 100 to support a ball 98 for connecting to the ball coupler 57. The vertical component 84 has stop lugs 108 and 108a attached to the top and to the bottom thereof respectively.

### OPERATION—PREFERRED EMBODIMENT

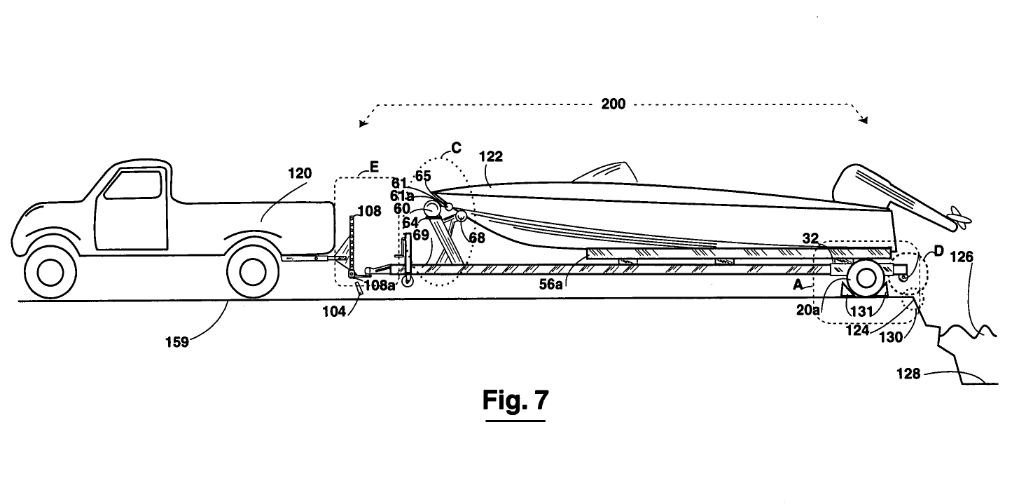

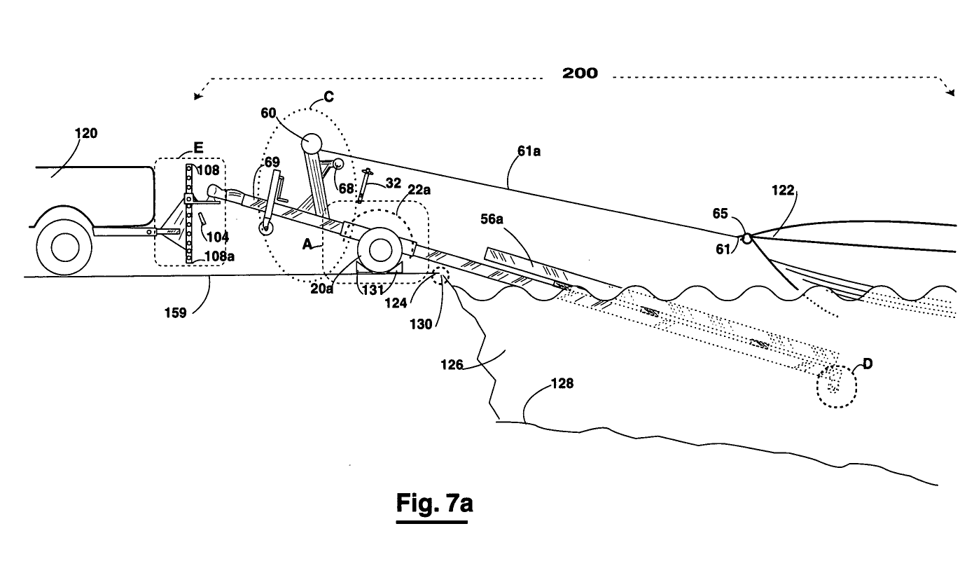

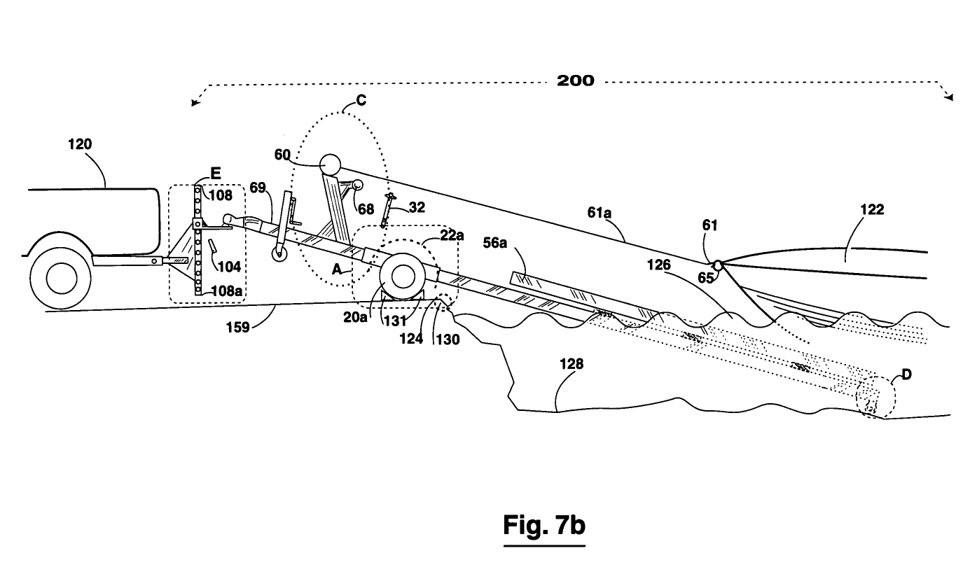

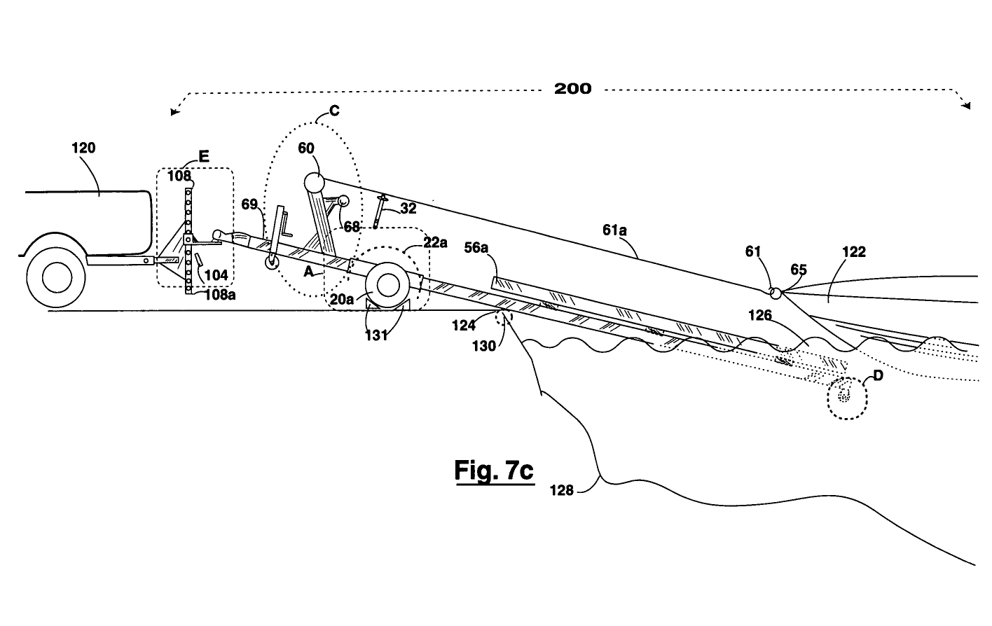

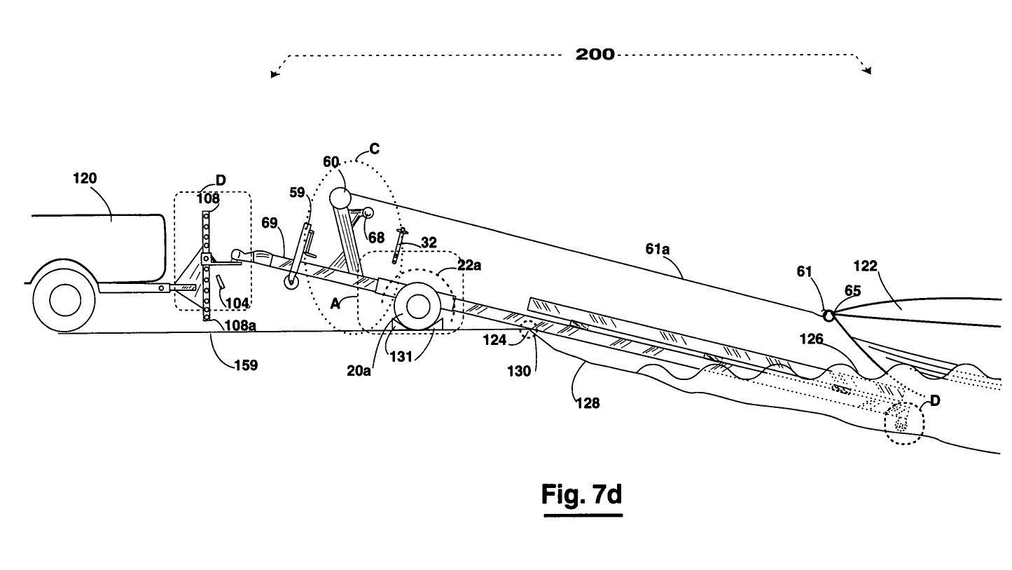

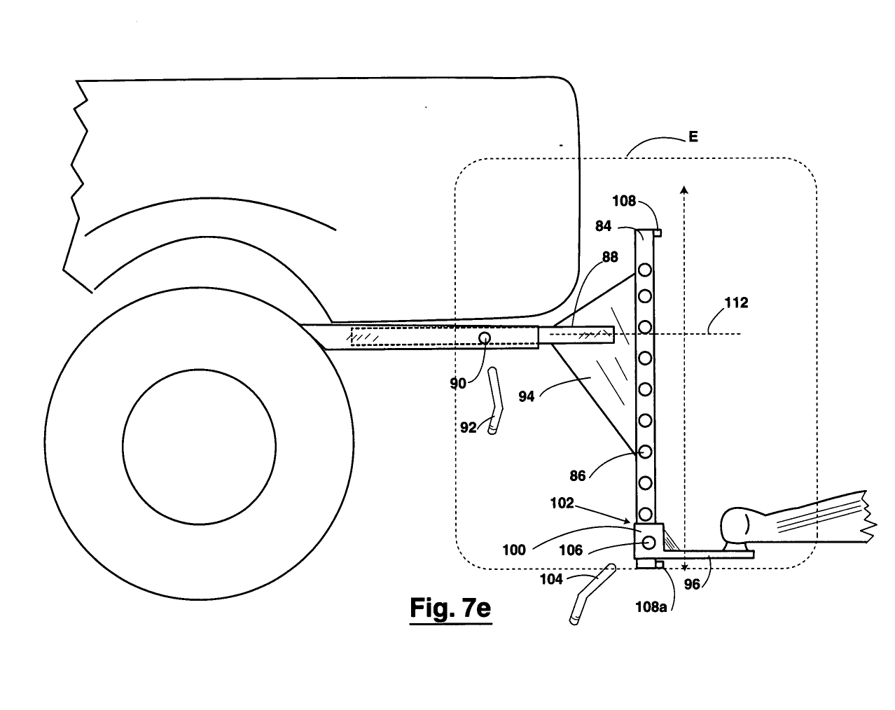

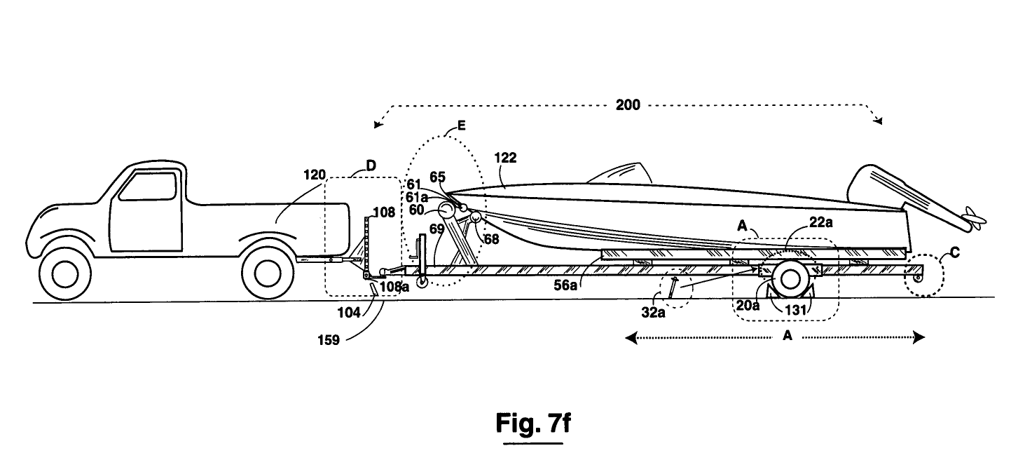

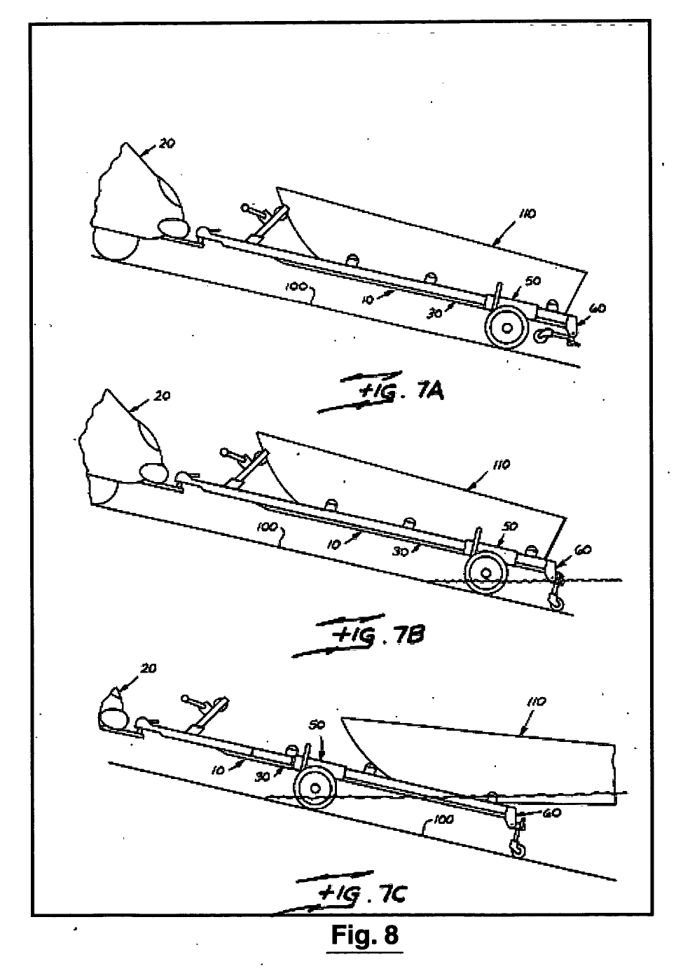

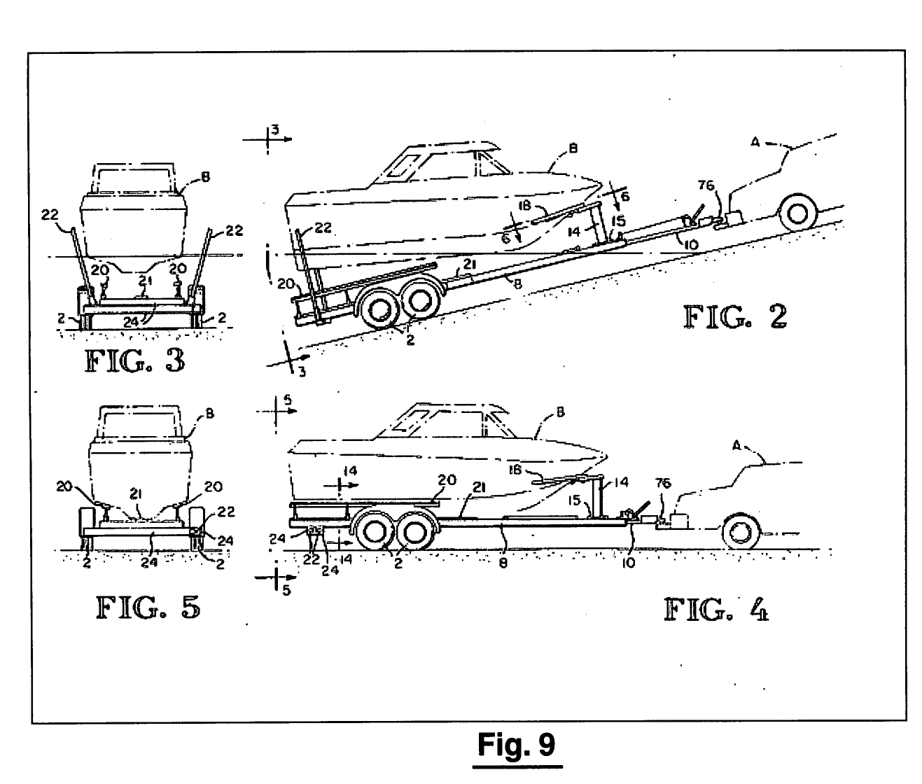

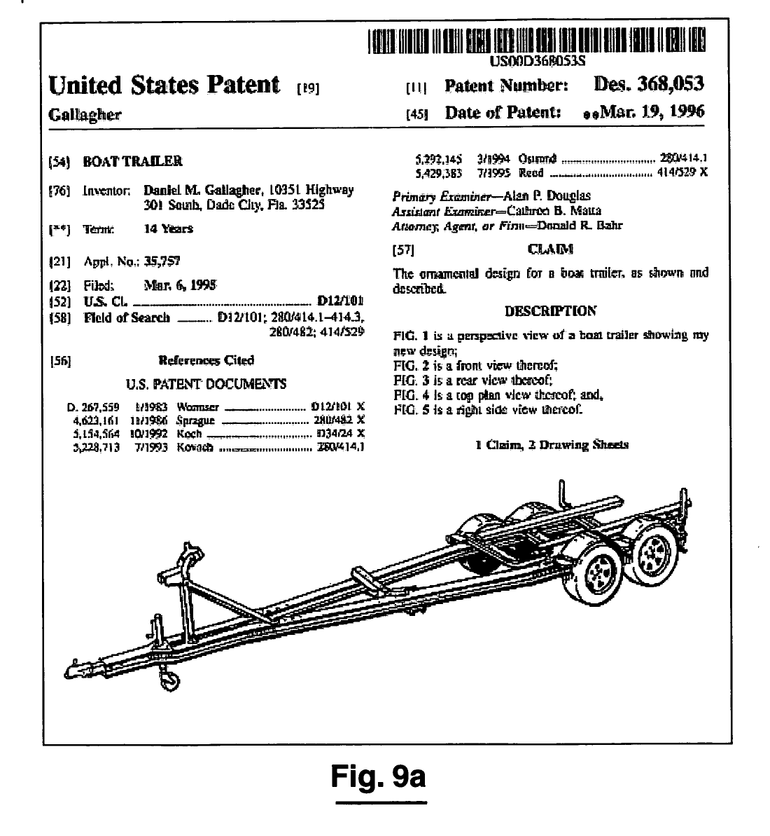

FIG. 7 shows a towing vehicle 120 and a boat trailer combination 200 in a ready for deployment position at the edge of a water-way 124 with no launching ramp.

The deployment procedure includes:
The wheels 20 and 20a are chocked 131 and/or the brakes are applied causing the slidable positioning suspension assembly A to remain stationary. The floating link adjustable height hitch assembly E bolt 104 is removed allowing the floating link adjustable height hitch assembly slide guide 100 to move vertically. The bolts 32 and 32a are removed from the slide/guides 26, and 26a respectively allowing the load bearing frame components 50 and 50d to move horizontally. The towing vehicle 120 is put in reverse motion. The towing vehicle's 120 reverse motion causes variable and simultaneous dynamics. The slidable positioning suspension assembly A remains stationary. The boat's 122 and the load bearing frame components B approach the water-way 126. The boat's 122 stern and the rear of the load bearing frame components B gradually lower. The boat's 122 bow and the load bearing frame components B gradually rise. The electrical cable 40 will gradually pivot on the transverse coil spring 41 best shown in FIG. 1a.

At this juncture some of the possible usage scenarios are, but not limited to, the following:

Scenario One FIG. 7a: Sufficient depth in the water 126 is attained for the boat 122 to float off of the bunk's 56 and 56a. The winch cable end hook 61 would be disconnected from the bow eye bolt 65 completing the deployment.

Scenario Two FIG. 7b: The roller wheels assembly D engages the water-way bottom 128 and continues to roll until a sufficient depth in the water 126 is attained for the boat 122 to float off, slide off, pushed off, or in the case of a motorized boat powered off of the bunk's 56 and 56a The winch cable end hook 61 would be disconnected from the bow eye bolt 65 completing the deployment.

Scenario Three FIG. 7c: The lower side of the load bearing frame components 50 and 50d rest and/or slide on the water-way's edge 124 at the contact point 130 and continues to slide until a sufficient depth in the water is attained for the boat 122 to float off, slide off, pushed off, or in the case of a motorized boat powered off of the bunk's 56 and 56a. The winch cable end hook 61 would be disconnected from the bow eye bolt 65 completing the deployment.

Scenario Four FIG. 7d: The lower side of the load bearing frame components 50 and 50d rest and/or slide on the water-way's edge 124 at the contact point 130 and the roller wheels assembly D engages the water-way bottom 128 and may continue to roll until a sufficient depth in the water is attained for the boat 122 to float off, slide off, pushed off, or in the case of a motorized boat powered off of the bunk's 56 and 56a. The winch cable end hook 61 would be disconnected from the bow eye bolt 65 completing the deployment.

The retrieval procedure is the opposite of the deployment procedure. The winch 60 would be utilized if the boat 122 did not float off the bunks 56 and 56a but slid off, pushed off, or in the case of a motorized boat powered off. In these “did not float off” instances the winch cable hook 61 would be reattached to the bow eye 65 and the winch would pull the boat 122 on to the bunks 56 and 56a Powering the boat 122 on to the bunks 56 and 56a is an option in the case of a motorized boat 126. The winch cable hook 61 would be reconnected to the bow eye 65 if it is not attached at this point. The towing vehicle 120 would be put in forward motion. The towing vehicle's 120 forward motion causes variable and simultaneous dynamics: The boat 122 and the load bearing frame components B gradually draw back from the water. The electrical cable 40 will gradually pivot on the transverse coil spring 41 best shown in FIG. 1a. The stern of the boat 122 and the rear of the load bearing frame components B will gradually rise. The bow of the boat 122 and the front of the load bearing frame components B will gradually lower returning the boat trailer combination 200 and towing vehicle 120 to the original position shown in FIG. 7. The bolts 32, and 32a are replaced in the respective slide guides 26 and 26a. The chock blocks 131 are removed and/or the brakes are released. The retrieval procedure is completed.

My boat trailer combination 200 has a slidable positioning suspension assembly A. A prior determination of the maximum weight capacity of the tongue or hitch should be made. One method of many is: before hooking to the boat trailer combination 200, load the rear of the towing vehicle 120 with the maximum amount of weight allowable for that particular vehicle; make a linear measurement from the ground plane to the hitch. Thereafter this figure may be used to make a proper determination as to the weight on the tongue or hitch E.

As determined by the necessary previous calculation the slidable positioning suspension assembly A may be appropriately positioned with regard to weight distribution by the following: The wheels 20 and 20a are chocked 131 and/or the brakes are applied causing the slidable positioning suspension assembly A to remain stationary. The bolt 104 is not removed from the hitch slide guide 100 opening 106. The bolts 32 and 32a are removed from the slide/guides 26, and 26a respectively allowing the load bearing frame components 50 and 50d to move horizontally. Depending upon the prior location of the slidable positioning suspension assembly A the towing vehicle 120 is put in either forward or reverse motion. The towing vehicle's 120 motion causes variable and simultaneous dynamics: The load bearing frame components 50 and 50d slide horizontally in the respective slide guides 26 and 26a forward or reverse as required positioning the slidable positioning suspension assembly A in the previously determined position for travel. The bolts 32, 32a are replaced in the respective slide guides 26 and 26a, the chock blocks 131 are removed and/or the brakes are released. My boat trailer combination 200 is ready to proceed with a properly positioned slidable positioning suspension assembly A shown in FIG. 7f.

One of the objectives of my boat trailer combination 200 is directed to making out of the way water bodies accessible to boat trailering. Irregular terrain will therefore be encountered. The towing vehicle 120 is often not on the same ground plane 159 as the boat trailer combination 200. The effect of the tongue of the trailer being confined to a static position combined with the irregular terrain would cause the force on the tongue to vary erratically. The handling characteristics of the towing vehicle 120 would be adversely and unpredictably affected as it proceeds along the irregular terrain. The floating link adjustable height hitch assembly E of my boat trailer combination 200 allows the tongue of my boat trailer combination to move vertically as required by the differences in the terrain beneath the towing vehicle 120 and that of boat trailer combination 200. This movement would relieve much if not all of the erratic changes in force on the towing vehicle 120.

The floating link adjustable hitch assembly E conforms to most configurations of a towing vehicle 120 and the boat trailer combination 200. It is foreseen that there are an infinite number of potential towing vehicles 120 the rear end height of which varies greatly. The floating link adjustable hitch assembly E design allows the trailer tongue to pass the horizontal axis 112 of the generic receiver 10d. Because of the asymmetrical design of the floating link adjustable hitch assembly E it may be reversed by removing it from the generic receiver and rotated and replaced in the generic receiver as shown in FIG. 7e. This provides an extreme alternate option for the movement of the hitch slide guide 100 past the horizontal axis 112 of the generic receiver 10d.

Full fenders 22 and 22a and the gussets 28 and 28a shield the slidable positioning suspension assembly from water and debris that may be carried on to the boat trailer combination 200 during retrieval.

The electrical cables are not immersed as a result of the coiled and spring bias electrical cable 40 connected to the tail/stop lights 23 and 23a pivoting on the transverse coil spring 41, best shown in FIG. 1a, during deployment and retrieval. The tail/stop lights 23 and 23a are not immersed as they are mounted on the slidable positioning suspension assembly fenders 22 and 22a that do not get submerged.

### CONCLUSION RAMIFICATION SCOPE—PREFERRED EMBODIMENT

My invention reveals a boat trailer combination, operated in conjunction with a towing vehicle, comprising a plurality of configured generic components, to launch and retrieve a boat into or out of the water, at or below the ground plane of the towing vehicle, without water contamination of the structural components thereof, without a launching ramp or extraneous apparatus.

Thus the reader will see that the preferred embodiment of the invention provides long felt but unfulfilled needs of the boat trailering public and the boating industry at large.

The preferred embodiment is made of aluminum. Other materials or processes or combinations thereof are foreseen to achieve the non-corrosive properties equal to or superior to that of aluminum.

The preferred embodiment's slidable positioning suspension assembly is seen having many and varied embodiments. Multiple axle suspension assemblies are envisioned as dictated by the size and weight of the boat carried. Variations on the preferred embodiment's slidable positioning suspension assembly torsion bars are seen to be extensive. Air bags, springs, and hydraulic components are among just a few possibilities. The prevailing conditions of given areas would make adaptations to the suspension necessary. Some examples are, but not limited to snow, ice, sand, mud, rocks.

The opening slots 36 and 36a in the guide slides 26 and 26a can be located on any of the four sides of the rectangular profile shown. This provides infinite possibilities in configuration for all types of boat hulls.

Other load bearing frame component B shapes and a corresponding shape of the suspension slide guides are envisioned. Some are, but not limited to I-beam, circular, elliptical, triangular, square as well as many rectangular aspect ratios are foreseen.

Many methods of fastening and releasing the slide guides both on the floating link adjustable height assembly D and the slidable positioning suspension assembly A are but not limited to, air, electrical, spring bias, and hydraulic.

The preferred embodiment of the hitch slide guide has possibilities with other complimenting shapes. The shapes and sizes of such designs are broad dependent on the size and weight of the boat trailered. Some are, but not limited to I-beam, circular, elliptical, triangular, square as well as many rectangular aspect ratios are foreseen.

My boat trailer combination has an floating link adjustable hitch height feature that offers a much broader range of adaptability to towing vehicles and the terrain traveled upon than that of the prior art. The floating link adjustable hitch assembly makes my boat trailer combination compatible with the height of a great number of generic hitch receivers. The floating link adjustable hitch assembly allows the ball coupler or tongue to pass the horizontal axis of the generic hitch receiver. The floating link adjustable hitch assembly being asymmetrical may be reversed by removing it from the generic receiver and rotated and replaced in the generic receiver with the longer portion of the vertical component up or down providing a broad range of generic hitch receiver height compatibility.

The floating link adjustable hitch assembly relieves the erratic force rendered to a towing vehicle by the boat trailer combination on irregular terrain. The addition of a shock absorbing element or device for the hitch floating action is envisioned.

A multitude of hitching methods and equipment is envisioned. A pintle hook is one of many.

The electrical components can be spared immersion in water in addition to the preferred embodiment hereof simply by their removal. However many methods for not immersing the electrical components are foreseen.

Many other embodiments of my boat trailer combination are possible. For example military embodiments that would provide rapid deployment and retrieval of fighters, weapons and equipment. Municipal police and fire departments need rapid deployment and retrieval of equipment for fire fighting, rescue operations and now anti-terrorist measures. A rescue vessel could be launched rapidly saving precious minutes in life threatening situations in water. Retrieval of the distressed would be enhanced by the rapid retrieval capability of my invention.

The winch may be substituted with many and varied devices such as, but not limited to, electrically driven, hand operated, and pulley operated.

The size and capacity of the components above are adaptable to the size and weight of any vehicle.

While my above description contains many specificities, these should not be construed as limitations on the scope of the invention, but rather as an exemplification of one preferred embodiment thereof.

### ADDITIONAL EMBODIMENT

### BACKGROUND OF THE ADDITIONAL EMBODIMENT—FIELD OF THE INVENTION

This invention relates to vehicular trailers; more particularly to multiple use vehicular trailers that deploy and retrieve vehicles.

### BACKGROUND OF THE ADDITIONAL EMBODIMENT—PRIOR ART

An additional embodiment of the present invention is a multiple use vehicular trailer combination. The operation is identical to the preferred embodiment hereof. Certain parts of which are deleted and certain parts are added and will be described hereafter. Vehicular trailers with movable beds are well known. All have a comparative complexity of design and a limited range of utility.

The prior art has no ready means to deploy or retrieve a vehicle below the ground plane of the towing vehicle. The prior art has no winch on a vehicular trailer.

The amount of weight at the tongue or ball coupling is critical to the safe handling faculties of the towing vehicle. The prior art has no flexibility in the vertical movement of the tongue or ball coupling when the towing vehicle and the trailer are underway on irregular terrain. On irregular terrain, the towing vehicle is often not on the same ground plane as the trailers. The effect of the tongue or ball coupling of the trailer being confined to a static position combined with the irregular terrain would cause the force on the tongue or ball coupling to vary erratically and unpredictably. The handling characteristics of the towing vehicle would be adversely affected as it proceeds along the irregular terrain.

Adjustable hitch assemblies are known in the art. However the range of adjustability is comparatively limited.

U.S. Pat. No. 5,137,414 to Sloan, et al. Aug. 11, 1992 FIG. 14 is a case in point. Sloan shows a complexity of parts that would need a substantial amount of maintenance and is comparatively expensive to produce. Sloan's design is limited to a narrow range of utility because of the restrictive design that would engage the ground only on a surface that is on the same plane as the towing vehicle. Sloan's design shows no way of pulling a vehicle on to the trailer bed. Apparently it could retrieve only operative vehicles, not wrecks nor non functioning vehicles.

U.S. Pat. No. 6,036,207 to Ochlerking Mar. 14, 2000 FIG. 14a is another case in point. Ochlerking shows a complexity of parts that would need a substantial amount of maintenance and is comparatively expensive to produce. Ochlerking's design is limited to a narrow range of utility because of the restrictive design that would engage the ground only on a surface that is on the same plane as the towing vehicle. Ochlerking's design shows no way of pulling a vehicle on to the trailer bed. Apparently it could retrieve only operative vehicles, not wrecks nor non-functioning vehicles.

### BACKGROUND—OBJECTS AND ADVANTAGES OF THE ADDITIONAL EMBODIMENT

A feature of my multiple use vehicular trailer is a vehicle may be deployed to or retrieved from a plane equal to or beneath that of the towing vehicle. An irregular place such as, but not limited to, hilly roads, ditches, the sides of road embankments, cliffs, and waterways to name but a few are accessible with my multiple use vehicular trailer.

The types of vehicles to be deployed or retrieved are varied, among them are, but not limited to, automobiles, motorcycles, snow mobile's, ATV's, air boat's, golf cart's, landscaping vehicle's, construction vehicles both wheeled and tracked, and grounded boat's.

My multiple use vehicular trailer has a readily adjustable suspension positioning system. A prior determination of the maximum weight capacity of the tongue or hitch should be made. One method of many is: before hooking to the multiple use vehicular trailer, load the rear of the towing vehicle with the maximum amount of weight allowable for that particular vehicle; make a linear measurement from the ground plane to the hitch. Thereafter this figure may be used to make a proper determination as to the weight on the tongue or hitch.

The asymmetrical design of my floating link adjustable hitch assembly enables simple adaptation to any height towing vehicle. My floating link adjustable hitch assembly provides a means for the tongue of the trailer to vertically pass the horizontal axis of a generic hitch receiver. The floating link adjustable hitch assembly may be reversed by removing it from a generic receiver, rotated and replaced in the generic hitch receiver; this has two advantages: 1. provides an extreme alternate option for the vertical movement of the tongue of the boat trailer combination and 2. an unparalleled range of height positioning options.

The floating link adjustable hitch assembly is designed to vertically pass the horizontal axis of the generic hitch receiver. There is no trailer hitch with all of the functionality of my floating link adjustable hitch assembly.

My multiple use vehicular trailer is well suited to wilderness locations. The accessibility of which is dependant on the towing vehicle. On irregular terrain, the towing vehicle is often not on the same ground plane as the boat trailer combination. The effect of the tongue of the trailer being confined to a static position combined with the irregular terrain would cause the force on the tongue to vary erratically. The handling characteristics of the towing vehicle would be adversely and unpredictably affected as it proceeds along the irregular terrain. The floating link adjustable height hitch assembly of my multiple use vehicular trailer allows the tongue of my boat trailer to move vertically as required by the differences in the terrain beneath the towing vehicle and that of the multiple use trailer combination. This movement would relieve much if not all of the erratic changes in force on the towing vehicle.

The wheels of my multiple use vehicular trailer remain in a place that is safe and stable while deploying or retrieving a vehicle to a place where it may not be safe and stable. My multiple use vehicular trailer upon engagement of a surface will roll on the surface if need be.

My multiple use vehicular trailer makes formerly inaccessible and desirable locations readily accessible. My multiple use vehicular trailer would greatly enhance the trailering industry's economic position.

Heavy equipment trailer many times employ elaborate hydraulics and multiple section separations. My trailer design would make any tractor capable of hauling heavy equipment because there is no need of hydraulics. With my multiple use vehicular trailer the dynamics that take place during deployment or retrieval make hydraulics unnecessary.

My multiple use vehicular trailer is simple and comparatively inexpensive to build. The build simplicity is a key to a minimum of maintenance. When compared with many of today's hydraulic and non-hydraulic vehicle recovery equipment, my trailer offers a substitute that is more practical. The practicality is in the fact a person with a common pick up truck would be able to efficiently do the work of a much more expensive recovery vehicle and do it in diverse areas of deployment or retrieval.

Other objects and advantages will become apparent from the specification and drawings.

### SUMMARY—ADDITIONAL EMBODIMENT

In accordance with the present invention a multiple use vehicular trailer combination comprising a plurality of configured generic components operating together with a towing vehicle to deploy or retrieve a variety of vehicles to and from a plane equal to or beneath that of a towing vehicle.

### DRAWINGS AND FIGURES—ADDITIONAL EMBODIMENT

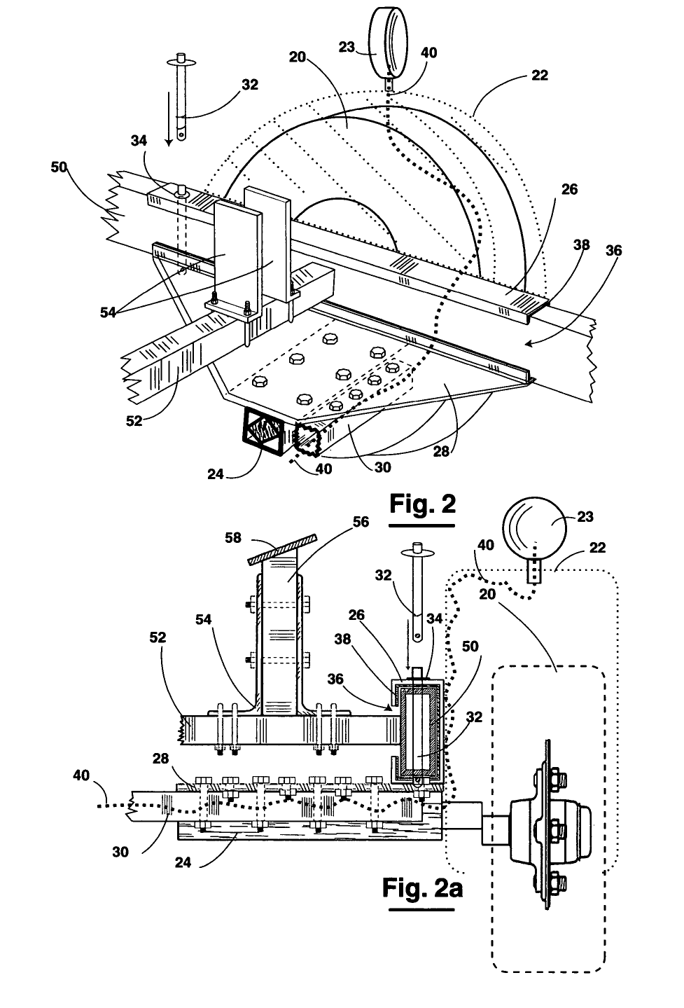

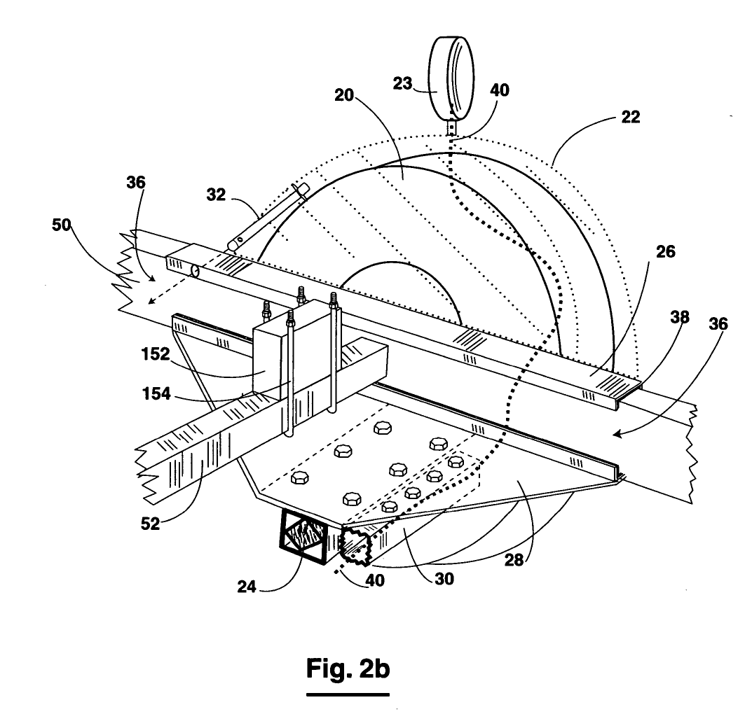

FIG. 2b a perspective view the right hand side of a suspension system components

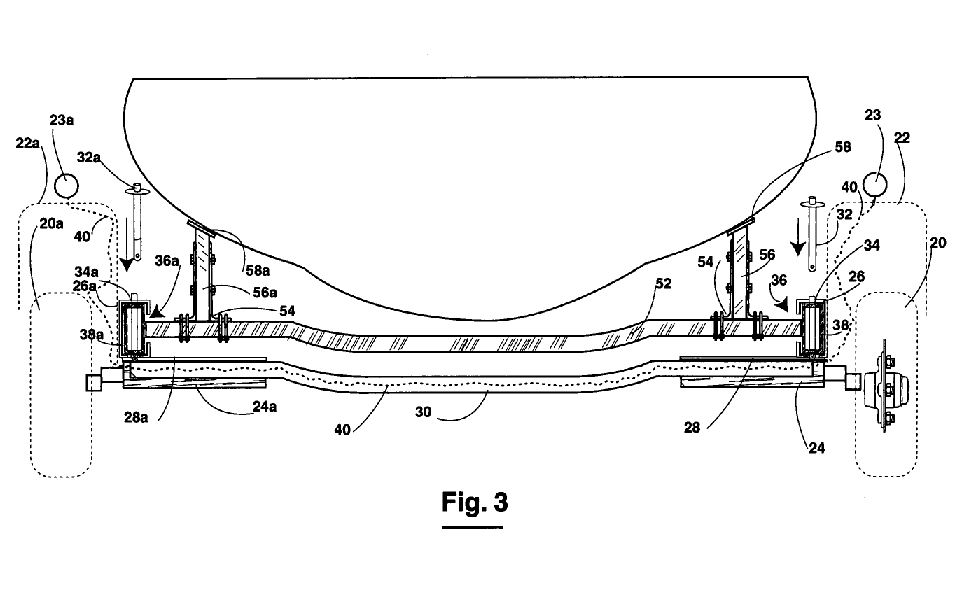

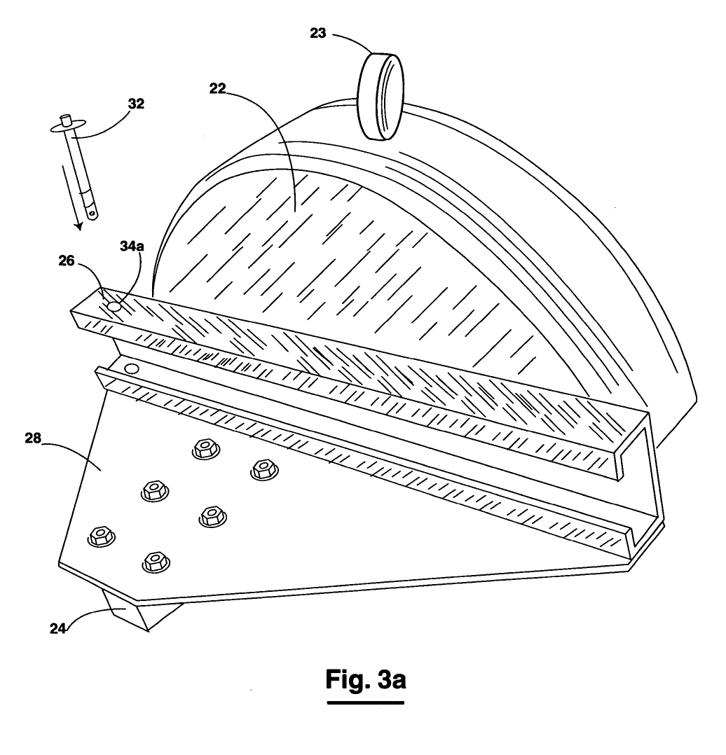

FIG. 3a a perspective view of the right hand side suspension system components with a full fender and the method of attaching a vehicle platform

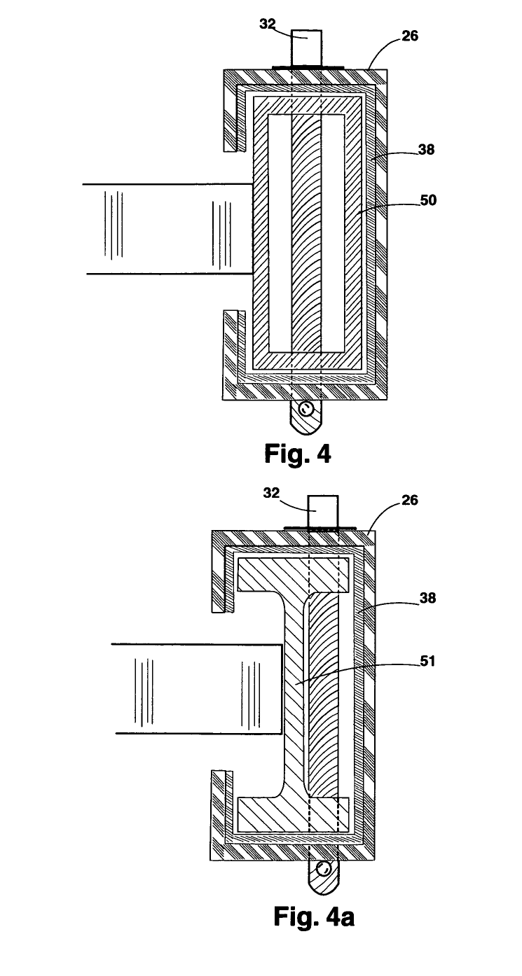

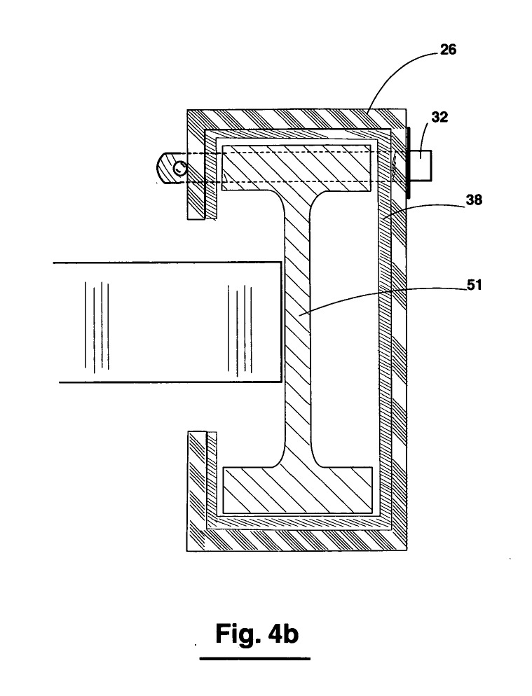

FIG. 4 a rear plane view of a slide/guide

FIG. 4a an alternative embodiment of a slide guide

FIG. 4b an alternative embodiment of a slide guide

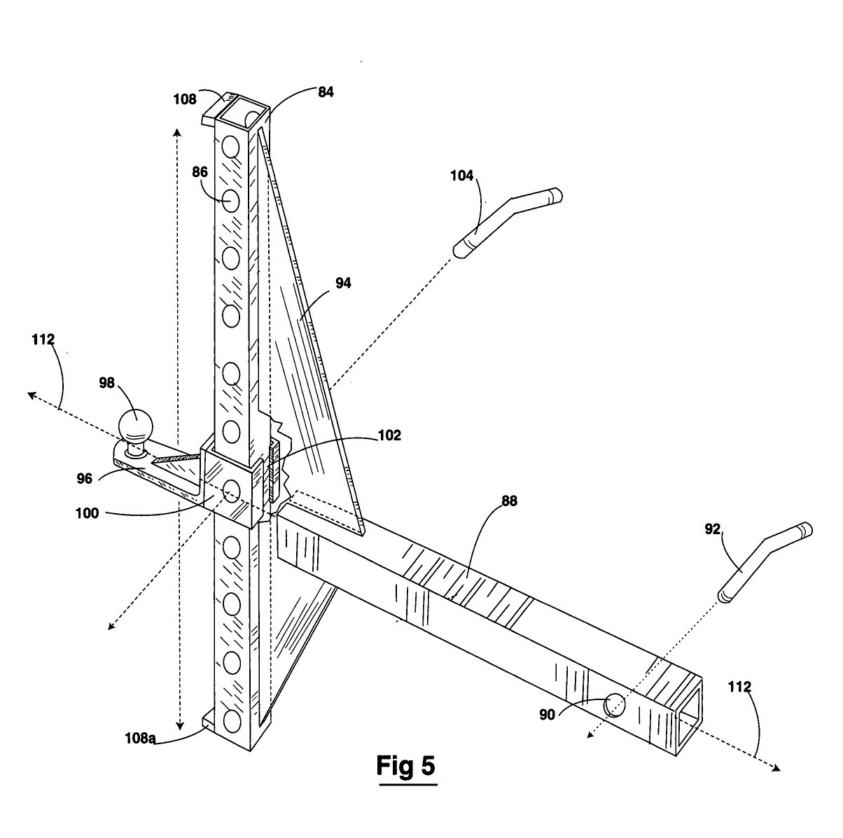

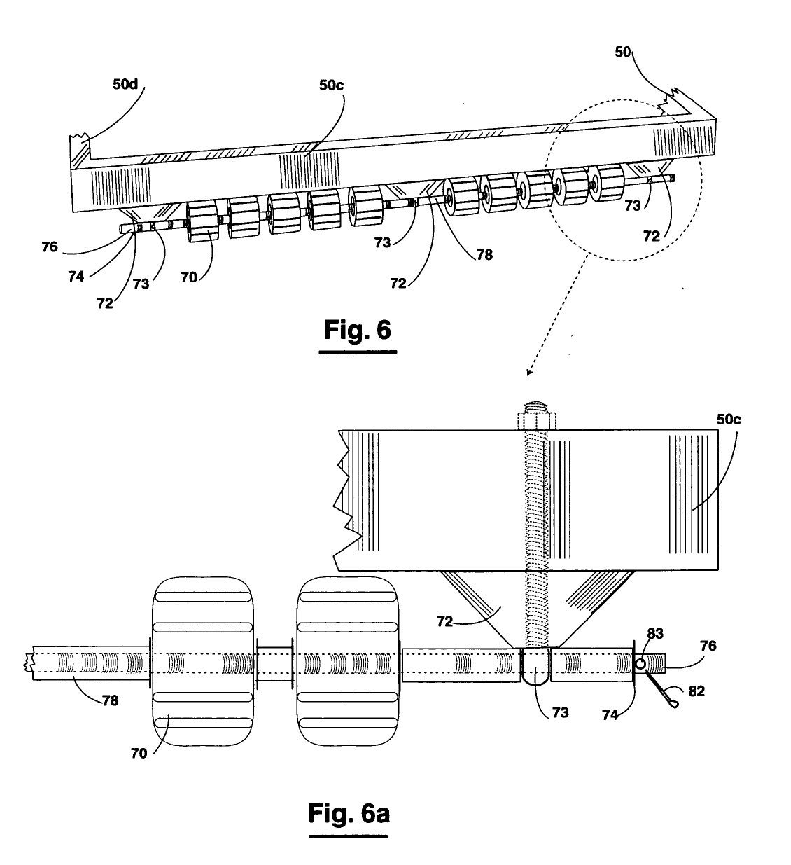

FIG. 5 a detailed perspective view of a floating link, adjustable height, hitch assembly

FIG. 7e a floating link adjustable hitch assembly reversed

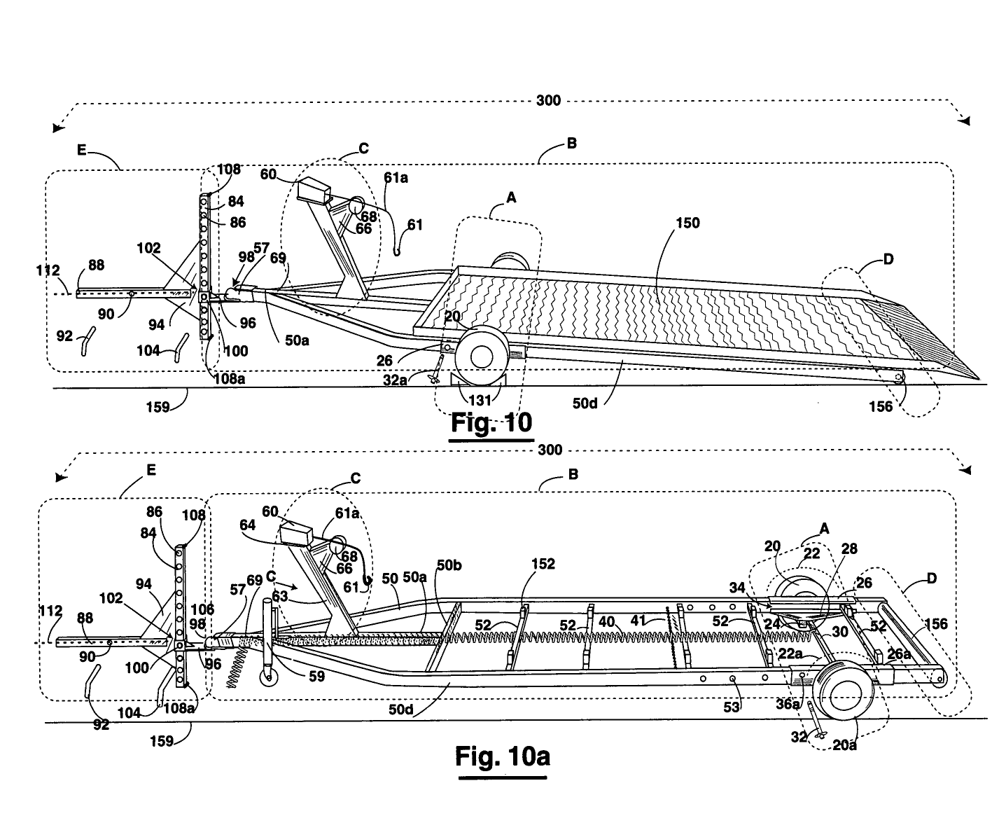

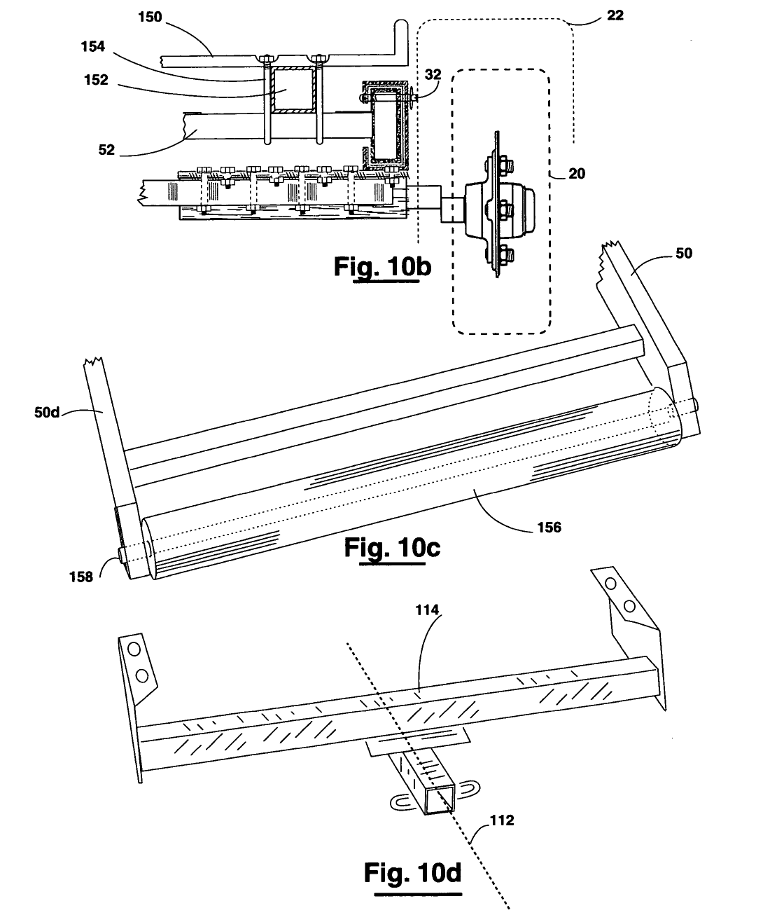

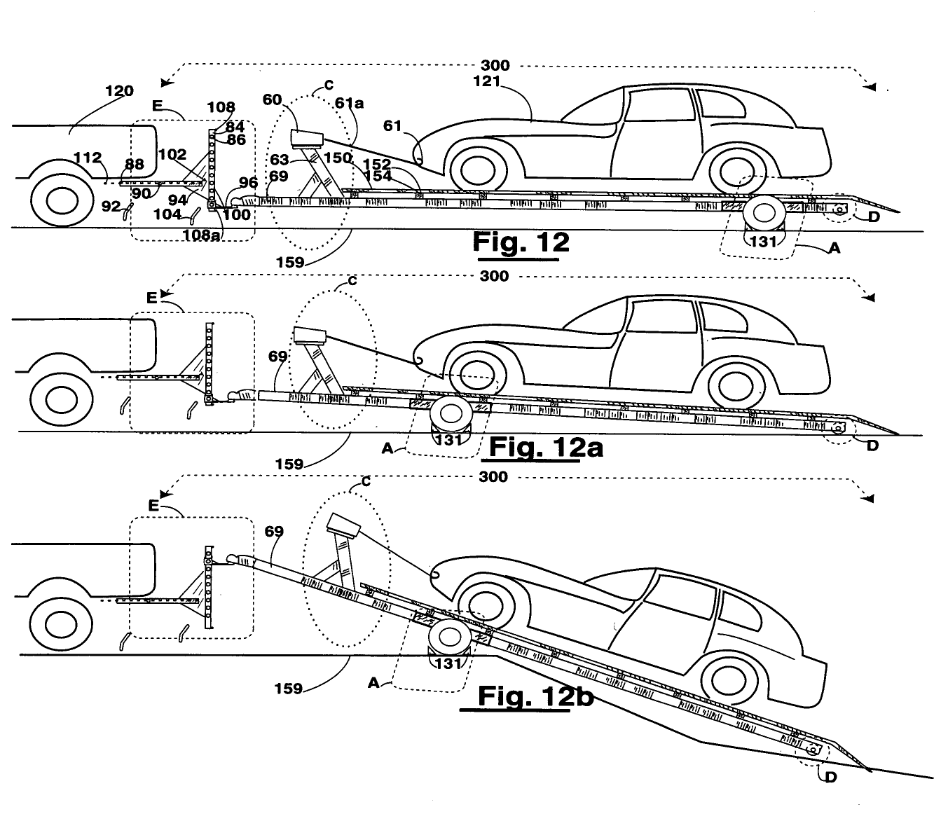

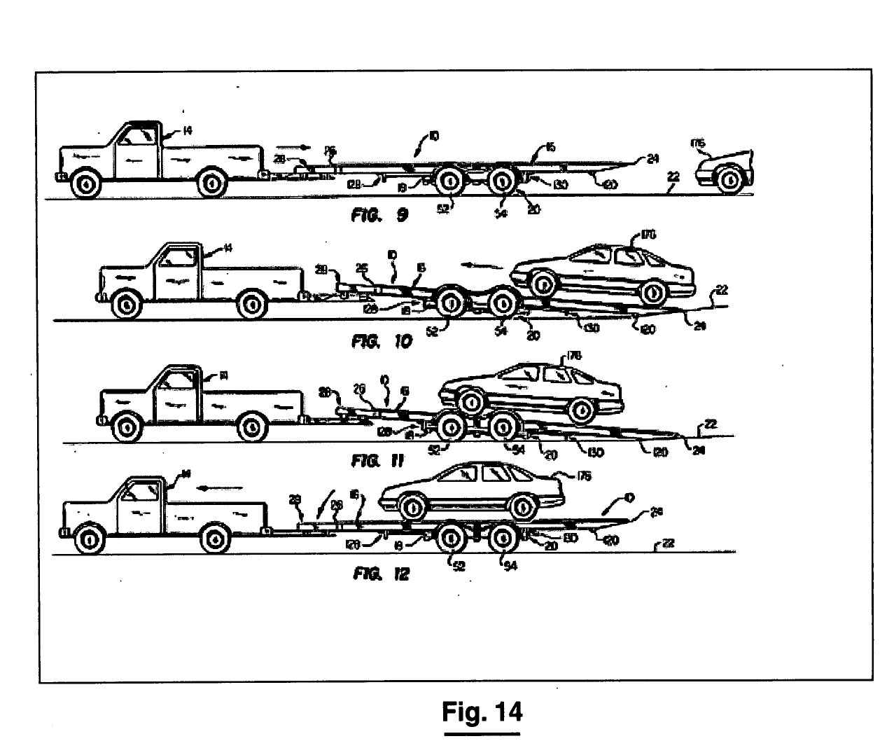

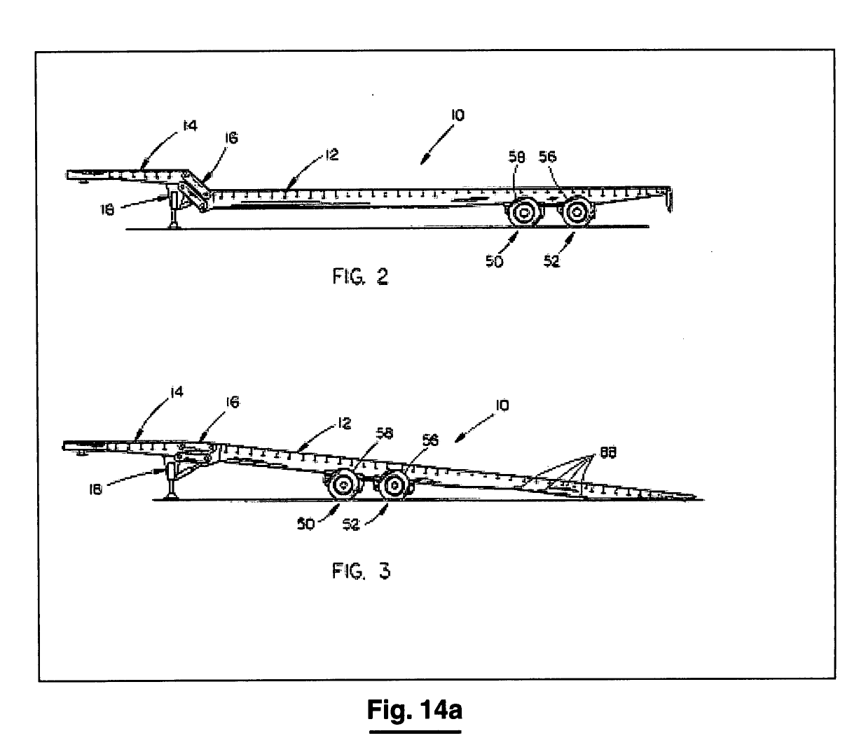

FIG. 10 a multiple use vehicular trailer with a vehicle platform

FIG. 10a the multiple use vehicular trailer without a vehicle platform

FIG. 10b a plane view of a method of attaching a vehicle platform to several transverse cross members

FIG. 10c a cylindrical roller assembly

FIG. 10d a generic hitch

FIG. 12 tow vehicle and a multiple use vehicular trailer in a prepared to deploy position

FIG. 12a the multiple use vehicular trailer is deployed engaging the ground on a plane equal to that of the towing vehicle

FIG. 12b the multiple use vehicular trailer is deployed engaging the ground on a plane below that of the towing vehicle

FIG. 14 U.S. Pat. No. 5,137,414 to Sloan, et al.

FIG. 14a U.S. Pat. No. 6,036,207 to Ochlerking

### DETAILED DESCRIPTION—ADDITIONAL EMBODIMENT FIGS. 10 and 10a

The overall structure of the preferred embodiment of the present invention is illustrated in FIG. 10 and FIG. 10a

FIG. 10 shows a multiple use vehicular trailer 300 with a vehicle platform 150.

FIG. 10a shows the multiple use vehicular trailer 300 without a vehicle platform 150 that includes:

A slidable positioning suspension assembly A composed of the following elements: A wheel 20 is attached to a torsion bar 24 on the right hand side of the multiple use vehicular trailer 300. A wheel 20a is attached to a torsion bar 24a on the left hand side of the multiple use vehicular trailer 300. A torsion bar 24 is attached to a gusset 28 on the right hand side of the multiple use vehicular trailer 300. A torsion bar 24a is attached to the gusset 28a on the left hand side of the multiple use vehicular trailer 300. A slide/guide 26 is attached to the gusset 28 on the right hand side of the multiple use vehicular trailer 300. A slide/guide 26a is secured to the gusset 28a on the left hand side of the multiple use vehicular trailer 300. A transverse axle 30 is attached to the gusset 28 on the right hand side of the multiple use vehicular trailer 300 and to the gusset 28a on the left hand side of the multiple use vehicular trailer 300.

A load bearing frame components assembly B composed of the following elements: A longitudinal load bearing frame component 50 on the right hand side of the vehicle trailer combination 300 is attached at the rear at a right angle to the right hand side of a transverse roller assembly 156 at the rear of the multiple use vehicular trailer 300. The left hand side of the transverse roller assembly 156 is attached at a right angle to the rear of longitudinal load bearing frame component 50d on the left hand side of the vehicle trailer combination 300. The front of the longitudinal load bearing frame component 50d is joined with the front of the forward longitudinal load bearing frame component 50a, and the front of the longitudinal load bearing frame component 50 on the right hand side of the vehicle trailer combination 300. The forward longitudinal load bearing frame component 50a is attached at the rear to a transverse forward load bearing frame component 50b.

Several transverse cross members 52 are attached to the longitudinal load bearing frame component 50 on the right hand side of the vehicle trailer combination 300 and to the longitudinal load bearing frame component 50d on the left hand side of the vehicle trailer combination 300. A transverse forward load bearing frame component 50b is attached to the longitudinal load bearing frame component 50 on the right hand side and to the longitudinal load bearing frame component 50d on the left hand side of the vehicle trailer combination 300. A plurality of u-bolts 154 and a plurality of rectangular spacers 152 connect the several transverse cross members 52 to the vehicle platform 150. A ball coupler 57 is attached to the front of the forward longitudinal load bearing. A trailer jack 59 is attached to the forward longitudinal load bearing frame component 50b.

A winch assembly C composed of the following elements:
a winch stand 63 is attached at its base to the longitudinal forward load bearing frame component 50a and the top of the winch stand 63 is attached to a winch mount 64. A winch 60 is attached to a cable 61a The cable 61a is attached to a winch cable hook 61. A bow stop bracket 66 is attached to the winch stand 62. A bow stop 68 is attached to the bow stop bracket 66.

A winch stand 63 is attached at its base to the longitudinal forward load bearing frame component 50a and the top of the winch stand 63 is attached to a winch mount 64. A winch 60 is attached to a cable 61a. The cable 61a is attached to a winch cable hook 61.

An electrical cable 40 is located inside of the forward longitudinal load bearing frame component 50a and exits through the middle of the transverse forward load bearing frame component 50b and then inside of the axle 30. The electrical cable 40 is divided and routed in the axle 30 to the brake, stop, and tail lights 23 and 23a on the fenders 22 and 22a A transverse coil spring 41 is located midway between the transverse forward load bearing frame component 50b and the axle 30 and attached to the load bearing frame component 50 on the right hand side of the vehicle trailer combination 300 and to the longitudinal load bearing frame component 50d on the left hand side of the vehicle trailer combination 300.

A roller assembly D composed of the following elements: A transverse cylindrical roller 156 with an axle 158 attached to the rear of the load bearing frame component 50 on the right hand side and the rear of the load bearing frame component 50d on the left hand side.

A floating link adjustable hitch assembly E composed of the following elements: A horizontal component 88 is linearly attached to and aligned with the horizontal axis of the vertex of the two shorter sides of the scalene triangular gusset 94. The longest side of the scalene triangle gusset 94 is attached to the longitudinal center of a vertical component 84. A slide/guide 100 surrounds the vertical component 84 except for a vertical slot 102 wider than the thickness of the scalene triangular gusset 94 allowing clearance for said slide guide to move vertically the full length of the vertical component 84. The vertical component 84 has several horizontally opposed openings 86 for the insertion or removal of a bolt 104 to secure or release the slide/guide 100 with a horizontally opposed opening 106 for the bolt 104. A ball mount 96 is attached to the slide/guide 100 to support a ball 98 for connecting to the ball coupler 57. The vertical component 84 has stop lugs 108 and 108a attached to the top and to the bottom thereof respectively.

### OPERATION—ADDITIONAL EMBODIMENT

FIG. 12 shows a towing vehicle and the multiple use vehicular trailer in a ready to deploy position. The deployment procedure includes: The wheels 20 and 20a are chocked 131 and/or the brakes are applied causing the slidable positioning suspension assembly A to remain stationary. The floating link adjustable height hitch assembly E bolt 104 is removed allowing the hitch slide guide 100 to move vertically. The bolts 32 and 32a are removed from the slide/guides 26, and 26a respectively allowing the load bearing frame components 50 and 50d to move horizontally. The towing vehicle 120 is put in reverse motion. The towing vehicle's 120 reverse motion causes variable and simultaneous dynamics: The slidable positioning suspension assembly A remains stationary. The vehicle 121 and the load bearing frame components B approach the ground plane 159. The vehicle's 121 rear and the rear of the load bearing frame components B gradually lower. The vehicle's 122 front end and the load bearing frame components B will gradually rise. The electrical cable 40 will gradually pivot on the transverse coil spring 41 best shown in FIG. 1a. This process will allow the multiple use vehicular trailer 300 to engage the ground on a plane equal to or beneath the plane of the towing vehicle. A cylindrical roller assembly 156 will allow the rear of the load bearing frame components B to roll on a surface. The winch cable hook 61 would be disconnected completing the deployment procedure.

The retrieval procedure is the opposite of the deployment procedure. The towing vehicle 120 would be put in forward motion. The towing vehicle's 120 forward motion causes variable and simultaneous dynamics: The vehicle 121 and the load bearing frame components B gradually draw back from the deployed position. The electrical cable 40 will gradually pivot on the transverse coil spring 41 best shown in FIG. 1a. The rear of the vehicle 121 and the rear of the load bearing frame components B will gradually rise. The front end of the vehicle 121 and the front of the load bearing frame components B will gradually lower returning the multiple use vehicular trailer 300 and towing vehicle 120 to the original position shown in FIG. 12. The bolts 32, 32a, and 104 are replaced.

My multiple use vehicular trailer 300 has an slidable positioning suspension assembly A. A prior determination of the maximum weight capacity of the tongue 69 or hitch should be made. One method of many is: Before hooking to the trailer combination, load the rear of the towing vehicle with the maximum amount of weight allowable for that particular vehicle; make a linear measurement from the ground plane to the hitch. Thereafter this figure may be used to make a proper determination as to the weight on the tongue or hitch.

As determined by the necessary previous calculation the slidable positioning suspension assembly A may be appropriately positioned with regard to weight distribution by the following: The wheels 20 and 20a are chocked 13 land/or the brakes are applied causing the slidable positioning suspension assembly A to remain stationary. The bolt 104 is not removed from the hitch slide guide 100. The bolts 32 and 32a are removed from the slide/guides 26, and 26a respectively allowing the load bearing frame components 50 and 50d to move horizontally. Depending upon the prior location of the slidable positioning suspension assembly A; the towing vehicle 120 is put in either forward or reverse motion. The towing vehicle's 120 motion causes variable and simultaneous dynamics: The load bearing components 50 and 50d slide horizontally in the respective slide guides 26 and 26a forward or reverse as required positioning the slidable positioning suspension assembly A in the previously determined position for travel. The bolts 32, 32a are replaced in the respective slide guides 26 and 26a, the chock blocks 131 are removed and/or the brakes are released. The multiple use vehicular trailer 300 is ready to proceed with a properly positioned slidable positioning suspension assembly.

### CONCLUSION RAMIFICATION SCOPE—ADDITIONAL EMBODIMENT

The additional embodiment of the present invention is a multiple use vehicular trailer, operated in conjunction with a towing vehicle, comprising a plurality of configured generic components, operating together to deploy or retrieve a variety of vehicles at or below the ground plane of the towing vehicle.

My multiple use vehicular trailer makes it possible to deploy or retrieve a variety of vehicles in irregular places such as, but not limited to, hilly roads, ditches, the sides of road embankments, cliffs, and waterways to name but a few.

The types of vehicles to be deployed or retrieved are varied, among them are, but not limited to, automobiles, motorcycles, snow mobile's, ATV's, air boat's, golf cart's, landscaping vehicle's, construction vehicles both wheeled and tracked, and grounded boat's.

The preferred embodiment's slidable positioning suspension assembly is seen as having many and varied embodiments. Multiple axle suspension assemblies are envisioned as dictated by the size and weight of the vehicle carried. Variations on the preferred embodiment's slidable positioning suspension assembly torsion bars are seen to be extensive. Air bags, springs, and hydraulic components are among just a few possibilities. The prevailing conditions of given areas would make adaptations to the suspension necessary. Some examples are, but not limited to snow, ice, sand, mud, rocks.

The opening slots 36 and 36a in the guide slides 26 and 26a can be located on any of the four sides of the rectangular profile shown. This provides infinite possibilities in configuration for all types of vehicle platforms.

Other load bearing frame component assembly B shapes and a corresponding shape of the suspension slide guides 26 and 26a are envisioned. Some are, but not limited to I-beam, circular, elliptical, triangular, square as well as many rectangular aspect ratios are foreseen.

Many methods of fastening and releasing the slide guides both on the floating link adjustable height assembly E and the slidable positioning suspension assembly A are but not limited to, air, electrical, spring bias, and hydraulic.

The preferred method of the hitch slide guide operation also has possibilities with other complimenting shapes. The shapes and sizes of such designs are broad, dependent on the size and weight of the vehicle trailered. Some are, but not limited to I-beam, circular, elliptical, triangular, square as well as many rectangular aspect ratios are foreseen.

The floating link adjustable hitch assembly being asymmetrical may be reversed by removing it from the generic receiver and rotated and replaced in the generic receiver with the longer portion of the vertical component up or down providing a broad range of generic hitch receiver height compatibility. It is foreseen that the addition of a shock absorbing element or device for the hitch floating action may be needed.

The floating link adjustable hitch assembly relieves the erratic force rendered to a towing vehicle by a vehicular trailer on irregular terrain. The addition of a shock absorbing element or device for the hitch floating action is envisioned.

A multitude of hitching methods and equipment is envisioned. A pintle hook is one of many.

The cylindrical roller assembly may be substituted with other ground engaging apparatus such as, but not limited to, skids, skis, pontoons, floats or platforms of many configurations.

The winch may be substituted with many and varied devices such as, but not limited to, air hydraulic, electrical, manual, and pulley operated.

The size and capacity of the components above are adaptable to the size and weight of any vehicle.

Many other embodiments are possible. For example military embodiments that would provide rapid deployment and retrieval of fighters, weapons and equipment. Municipal police and fire departments need rapid deployment and retrieval of equipment for fire fighting, rescue operations and now anti-terrorist measures. A rescue vehicle could be launched rapidly saving precious minutes in life threatening situations. Retrieval of the distressed would be enhanced by the rapid retrieval capability of my multiple use vehicular trailer.

While my above description contains many specificities, these should not be construed as limitations on the scope of the invention, but rather as an exemplification of one preferred embodiment thereof.

1 A method of manufacturing a vehicular trailer operated in conjunction with a towing vehicle, comprising a plurality of configured generic components, to deploy and retrieve an object without a ramp or extraneous apparatus at or below a ground plane of said towing vehicle.

2 Said vehicular trailer of claim 1 wherein a boat trailer combination is the preferred embodiment.

3 Said boat trailer combination of claim 2 includes a suspension system slidably attached to a load bearing frame structure enabling said frame structure to pass over the vertical axis of said suspension system.

4 The boat trailer combination of claim 2 wherein including a means to apply force so as to cause or tend to cause motion toward the source of the force

5 Said boat trailer combination of claim 2 wherein including a means for said frame structure to engage a surface with a rotatable means allowing said frame structure to roll along said surface.

6 Said boat trailer combination of claim 2 wherein including a means for hitching said towing vehicle to a trailer; said hitching means with a slidable height faculty; said slidable height faculty enabling said boat trailer combination to operate below said ground plane of said towing vehicle; said slidable height faculty further enabling the tongue on said boat trailer combination to pass vertically the horizontal axis of a generic hitch receiver.

7 Said vehicular trailer of claim 1 wherein a multiple use vehicular trailer is an additional embodiment.

8 Said multiple use vehicular trailer of claim 7 wherein including a suspension system slidably attached to a load bearing vehicle platform enabling said vehicle platform to pass over the vertical axis of said suspension system.

9 Said multiple use vehicular trailer combination of claim 7 wherein including a means to apply force so as to cause or tend to cause motion toward the source of the force.

10 Said multiple use vehicular trailer of claim 7 wherein including a means for said vehicle platform to engage a surface with a rotatable means allowing said frame to roll along a surface.

11 Said multiple use vehicular trailer of claim 7 wherein including a means for hitching said towing vehicle to a trailer; said hitching means with a slidable height faculty; said slidable height faculty enabling said boat trailer combination to operate below the ground plane of said towing vehicle; said slidable height faculty further enabling the tongue on said boat trailer combination to pass vertically the horizontal axis of a generic hitch receiver
